(19) United States
(12) Patent Application Publication
(10) Pub. No.: US 2026/0203599 A1
(43) Pub. Date: Jul. 16, 2026

(54) SYSTEM FOR FEDERATED LEARNING-DRIVEN INTELLIGENT DATA MESH WITH AUTOMATED METADATA MANAGEMENT AND COMPLIANCE ENFORCEMENT

(71) Applicant: Godavari MODALAVALASA, Glen Allen, VA (US)

(72) Inventor: Godavari MODALAVALASA, Glen Allen, VA (US)

(21) Appl. No.: 19/556,961

(22) Filed: Mar. 4, 2026

(51) Int. Cl. G06N 3/098

(52) U.S. Cl. CPC G06N 3/098

(57) ABSTRACT

The present invention relates to a federated learning-driven intelligent data mesh system and method with automated metadata management and compliance enforcement. The invention provides a distributed architecture comprising a plurality of domain nodes configured to perform localized machine learning model training on domain-resident datasets while preventing export of raw data beyond respective domain boundaries. Each domain node includes a federated training processor, a metadata acquisition processor, a semantic harmonization processor, a compliance validation processor, and a hardware cryptographic processor for encrypting and digitally signing model parameter updates. A mesh coordination computing assembly receives encrypted model updates, authenticates participating nodes, performs secure aggregation to compute a global model update, constructs and maintains a directed acyclic lineage graph representing cross-domain data transformations, and evaluates regulatory constraints against harmonized metadata.

### FIELD OF THE INVENTION

The present disclosure relates generally to distributed data processing systems and, more particularly, to a system and method for implementing a federated learning-driven intelligent data mesh incorporating automated metadata management and compliance enforcement through structurally integrated hardware and software modules configured for distributed governance, adaptive model training, and real-time regulatory validation.

### BACKGROUND OF THE INVENTION

Modern enterprises generate large-scale heterogeneous data across distributed computational domains including edge devices, cloud clusters, on-premises servers, and hybrid infrastructures. Conventional centralized data lake architectures suffer from latency, bandwidth constraints, regulatory risks, and governance fragmentation. While federated learning allows decentralized model training without direct data exchange, existing implementations lack integrated metadata orchestration, automated policy propagation, lineage tracking, and machine-enforced compliance validation across domain boundaries. Furthermore, present systems fail to provide structural hardware configurations that ensure secure telemetry capture, immutable compliance logging, and dynamic model orchestration across domain-specific nodes.

Accordingly, there exists a need for a structurally integrated system and method that combines federated learning, intelligent metadata mesh coordination, automated compliance enforcement, cryptographic lineage anchoring, and distributed hardware modules capable of ensuring traceability, governance, and secure adaptive analytics in real time.

Modern enterprises face a rapidly growing need to manage, govern, and extract value from large volumes of heterogeneous data produced across distributed environments, and a number of architectural and technique approaches have emerged to address these needs—each with important capabilities but also significant limitations. Traditional centralized solutions, typified by monolithic data lakes and cloud-centric analytics platforms, attempt to consolidate raw data into a single store for downstream processing and model training; these platforms simplify global visibility and permit powerful centralized indexing and query optimization, but they introduce high network transfer costs, single points of regulatory and security failure, and brittleness in the face of jurisdictional data-residency constraints and latency-sensitive edge use cases. To reduce the friction of centralization, data virtualization and federated query systems emerged, offering a logical consolidation layer that leaves data at source while exposing unified query interfaces; however, these systems often struggle with divergent schema semantics, inconsistent metadata quality, and limited support for complex model training across non-identically distributed (non-IID) datasets, and they typically lack integrated mechanisms for automated policy enforcement and immutable audit trails at the scale demanded by regulated industries. Data mesh as an organizational paradigm moves governance and product thinking to decentralized domain teams, and technology implementations of a data mesh rely on domain-oriented data product registries, federated governance policies, and self-serve platform tooling. While data mesh improves ownership and motivates local curation, practical deployments reveal recurrent problems: metadata remains heterogeneous and inconsistently applied across domains, lineage information is frequently partial or manually curated, policy propagation is slow and error-prone, and there is no widely adopted, machine-actionable ontology for automated compliance verification, causing governance to revert to manual intervention or expensive consultancy-driven remediation. In parallel, federated learning has matured as an approach for collaborative model training that preserves data locality by exchanging model updates rather than raw data. Federated learning frameworks enable privacy-preserving collaboration across institutions and edge devices and can incorporate cryptographic techniques such as secure aggregation, secure multi-party computation (MPC), and differential privacy to reduce leakage risk. Nevertheless, federated learning faces a set of entrenched technical challenges: communication overheads associated with frequent gradient exchanges, model convergence difficulties on highly heterogeneous, skewed, or sparse local datasets, vulnerability to byzantine or poisoned updates, complexity in handling asynchronous participation and straggler nodes, and the need for robust mechanisms to attest, authenticate, and audit participating clients. Moreover, most federated learning deployments operate independently of enterprise metadata and governance stacks, so models trained in federated cycles lack rich, standardized metadata about provenance, data transformations, and compliance context, which complicates regulatory reporting and post-hoc explainability. Existing metadata management tooling—catalogs, data dictionaries, and metadata repositories—provide searchability and some lineage tracing, but they are often implemented as add-on services requiring manual tagging, mapping, and reconciliation. Automated metadata extraction pipelines exist for schema extraction and basic lineage, but they struggle with complex transformation logic in ETL/ELT code, user-defined functions, and machine learning pipelines; they also underperform when faced with polyglot storage, streaming sources, and highly nested semi-structured formats. The lack of semantic harmonization across domains and absence of machine-readable policy semantics mean metadata systems cannot reliably drive automated compliance checks, leaving enforcement to human review or coarse-grained blocking mechanisms that disrupt legitimate business processes. Compliance engines and policy enforcement tools typically function as separate governance layers that either block access at gateways or provide advisory checks in CI/CD pipelines; these approaches create latency, reduce agility, and often lack the granularity to enforce rules tied to model training cycles, lineage artifacts, or dynamic consent states. Attempts to integrate compliance using external audit ledgers or blockchain anchoring introduce tamper-evidence and stronger non-repudiation, but public or permissioned ledger anchoring presents cost and scalability trade-offs, introduces operational complexity, and does not by itself solve the problem of deriving machine-readable, up-to-date compliance state from fragmented metadata sources. Security and identity management solutions provide device and user attestation and key management, yet their integration into federated training systems and metadata meshes is uneven; device-bound identities and hardware security modules can enforce stronger trust, but legacy edge devices and diverse cloud environments often lack the necessary secure hardware, resulting in inconsistent trust guarantees. From an operational standpoint, orchestration platforms and model registries provide lifecycle management for models, but they are rarely linked to real-time metadata and compliance signals that would allow automated gating, adaptive retraining, or selective participation based on regulatory constraints. This disconnect means organizations either accept compliance gaps or build brittle point solutions that do not generalize. Performance-wise, hardware-accelerated inference and training at the edge remain an attractive proposition to reduce latency and preserve privacy, but designing appliances or embedded units that combine high-performance ML accelerators, tamper-resistant key stores, telemetry capture, and policy enforcement circuitry with the ruggedness and cost profile suitable for enterprise deployment is non-trivial; many proposed hardware designs are either too specialized, too expensive, or insufficiently integrated with software governance layers. In addition, incentive alignment and economic models for federated participation—particularly where cross-organizational collaboration is required—are underdeveloped; without fine-grained measurement of contribution, provenance, and auditability, incentive mechanisms and dispute resolution remain difficult to implement. Taken together, these existing solutions demonstrate partial progress toward distributed intelligence and governance but suffer from fragmentation across model training, metadata management, compliance enforcement, and hardware trust anchors. The key drawbacks are inconsistent and manual metadata hydrology, weak integration between federated learning and governance systems, limited machine-actionable policy semantics and propagation, scalability and performance limitations in ledger and cryptographic anchoring approaches, vulnerability to adversarial updates and non-IID data distributions, and the absence of a compact, deployable device design that reconciles the needs for high-performance training, secure identity, telemetry capture, and deterministic compliance enforcement. These gaps motivate a convergent approach that unifies federated learning, automated metadata orchestration, machine-readable compliance semantics, tamper-resistant auditability, and hardware-assisted enforcement into a cohesive intelligent data mesh capable of scalable, auditable, and regulation-aware collaborative analytics.

### SUMMARY OF THE INVENTION

The present disclosure provides a federated learning-driven intelligent data mesh system comprising a plurality of domain-specific data nodes interconnected through a mesh coordination fabric, a federated aggregation engine, an automated metadata orchestration module, a compliance enforcement engine, and a structurally integrated intelligent data mesh device configured to perform secure distributed training, policy validation, and metadata harmonization. The system ensures that domain data remains locally resident while model parameters, metadata descriptors, and compliance states are securely synchronized across the mesh through encrypted communication channels and cryptographically verifiable audit structures.

The invention further discloses a method for federated training and governance enforcement wherein domain-specific nodes execute localized model training, generate structured metadata signatures, validate compliance constraints through rule engines, and transmit encrypted gradient updates to an aggregation core. The aggregation core computes a global model update and propagates compliance-bound policies and metadata harmonization directives back to domain nodes.

Additionally, a dedicated intelligent data mesh device is disclosed as a physical machine comprising secure processing circuitry, hardware-based cryptographic modules, telemetry acquisition interfaces, memory subsystems, and compliance enforcement circuitry, enabling structural deployment within distributed enterprise infrastructures.

It is an object of the present invention to provide a system and method for federated learning-driven intelligent data mesh that enables decentralized model training across distributed domain nodes while ensuring that raw data remains locally resident within each respective domain, thereby preserving data sovereignty, minimizing network bandwidth consumption, and reducing exposure to centralized breach risks. The invention seeks to overcome limitations associated with monolithic data lakes and loosely integrated federated frameworks by establishing a structurally coordinated mesh architecture that integrates model aggregation, metadata harmonization, and compliance validation within a unified operational fabric.

Another object of the invention is to provide automated metadata management capable of extracting, normalizing, and synchronizing schema definitions, lineage descriptors, ownership attributes, transformation logs, and access control parameters across heterogeneous data repositories, including structured, semi-structured, and streaming sources. The invention aims to ensure that metadata is machine-readable, semantically harmonized, and dynamically updated so that it can be used not only for cataloging and discovery but also for automated governance enforcement, model provenance tracking, and explainability assurance.

It is a further object of the invention to provide interoperability across heterogeneous computational environments by implementing standardized communication protocols, cryptographic identity provisioning mechanisms, and ontology mapping functions that allow diverse domain nodes to participate in a coherent mesh without requiring uniform storage technologies or software stacks. The invention aims to reduce integration friction and facilitate scalable enterprise adoption.

Another object of the invention is to provide enhanced transparency and explainability for machine learning models trained in distributed environments by maintaining comprehensive lineage graphs linking datasets, transformations, model versions, and compliance states, thereby enabling traceable reconstruction of model evolution and facilitating audit, debugging, and risk assessment processes.

It is also an object of the invention to reduce latency in distributed analytics workflows by enabling localized inference and partial training at domain nodes equipped with hardware accelerators, while synchronizing only essential model parameters and metadata across the mesh. This configuration is intended to optimize network efficiency and ensure real-time responsiveness for mission-critical applications.

A further object of the invention is to provide robust resilience against node failures, communication interruptions, and asynchronous participation by implementing fault-tolerant aggregation logic, secure re-synchronization protocols, and state reconciliation mechanisms within the mesh coordination fabric, thereby ensuring continuity of federated training and governance operations.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for a federated learning-driven intelligent data mesh system with automated metadata management and compliance enforcement; and

FIG. 2 displays flow chart of a method for a computer-implemented method for federated learning-driven intelligent data mesh operation with automated metadata management and compliance enforcement.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

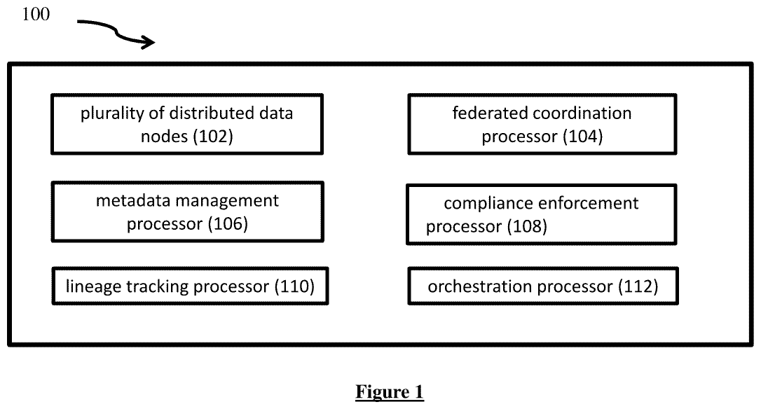

Referring to FIG. 1, a block diagram of a system for a federated learning-driven intelligent data mesh system with automated metadata management and compliance enforcement is illustrated. The system 100 comprising: a plurality of distributed data nodes (102), each data node comprising a local data storage device, a local processor, a local memory, and a communication interface, the local processor being configured to train a machine learning model on locally stored datasets without transmitting raw data outside the respective data node; a federated coordination processor (104) in communication with the plurality of distributed data nodes through a secure communication network, the federated coordination processor comprising a central processing circuit, a secure aggregation memory, and a cryptographic interface, wherein the federated coordination processor is configured to receive encrypted model parameters from each distributed data node, to perform secure aggregation of the encrypted model parameters, and to generate an updated global model; a metadata management processor (106) coupled to a metadata repository stored in a non-transitory storage device, the metadata management processor being configured to automatically extract structural metadata, operational metadata, lineage metadata, and policy metadata from each distributed data node, to normalize the extracted metadata into a unified schema, and to maintain a version-controlled metadata graph representing relationships between datasets, processing operations, model versions, and access policies; a compliance enforcement processor (108) coupled to a policy rule storage device, the compliance enforcement processor being configured to evaluate data access requests and model update operations against regulatory policies, organizational governance rules, and jurisdiction-specific data residency constraints, and to generate enforcement signals that selectively permit, restrict, or condition execution of data operations within the plurality of distributed data nodes; a lineage tracking processor (110) configured to generate immutable lineage records corresponding to dataset transformations, model training iterations, parameter aggregation events, and deployment actions, and to store the lineage records in a tamper-evident distributed ledger storage; and an orchestration processor (112) configured to coordinate execution sequences among the distributed data nodes, the federated coordination processor, the metadata management processor, and the compliance enforcement processor, wherein the orchestration processor enforces dependency constraints and synchronization intervals for federated learning rounds, metadata updates, and compliance validation cycles.

In an embodiment, each distributed data node (102) further comprises a differential privacy processor configured to apply noise injection to locally computed model gradients prior to encryption, the noise injection being dynamically parameterized based on sensitivity levels derived from metadata classifications stored in the metadata repository, thereby ensuring privacy preservation while maintaining model convergence characteristics.

In an embodiment, the federated coordination processor (104) further comprises a secure multi-party computation processor configured to perform parameter aggregation using encrypted arithmetic operations without decrypting individual model parameters, and wherein the secure aggregation memory stores temporary encrypted tensors until completion of aggregation across all participating distributed data nodes.

In an embodiment, the metadata management processor (106) further comprises a semantic alignment processor configured to map heterogeneous schema definitions from different distributed data nodes into a canonical ontology stored in the metadata repository, and wherein the semantic alignment processor performs automated entity resolution and attribute harmonization using learned schema matching models.

In an embodiment, the compliance enforcement processor (108) further comprises a jurisdiction detection processor configured to determine geographic origin of each dataset and model parameter based on network identifiers and stored data residency attributes, and to automatically enforce geographic boundary restrictions by preventing cross-border parameter aggregation when prohibited by stored regulatory policies.

In an embodiment, the lineage tracking processor (110) further comprises a cryptographic hashing processor configured to generate hash values for each lineage record, and to link successive lineage records through chained hash references to form an immutable audit trail resistant to unauthorized modification.

In an embodiment, the orchestration processor (112) further comprises a resource allocation processor configured to allocate computational resources across the plurality of distributed data nodes based on workload metrics, data volume characteristics, and historical convergence rates, thereby optimizing federated learning round completion time while maintaining compliance constraints.

In an embodiment, the metadata management processor (106) is further configured to automatically classify datasets using a machine learning classifier trained to identify personally identifiable information, financial data, health-related information, and confidential enterprise data, and to assign compliance tags that are subsequently consumed by the compliance enforcement processor during rule evaluation.

In an embodiment, the compliance enforcement processor (108) is further configured to perform pre-execution simulation of a requested data processing workflow by evaluating potential metadata state transitions and lineage impacts, and to deny execution if the simulated workflow violates stored governance rules or introduces prohibited data propagation paths within the metadata graph.

In an embodiment, each distributed data node (102) further comprises a telemetry collection processor configured to monitor training duration, gradient variance, model accuracy metrics, and data drift indicators, and to transmit summarized telemetry data to the metadata management processor, wherein the metadata management processor updates performance attributes within the metadata repository to support adaptive compliance and orchestration decisions.

In an embodiment, the differential privacy processor of each distributed data node is configured to determine the sensitivity levels by retrieving dataset classification tags from the metadata repository through the metadata management processor, generating a privacy budget value corresponding to each classification tag, partitioning locally computed model gradients into gradient segments corresponding to classified data attributes, injecting calibrated stochastic perturbations into each gradient segment based on the respective privacy budget value, and generating a perturbed gradient vector that is subsequently encrypted and transmitted to the federated coordination processor.

In an embodiment, the differential privacy processor operates as a tightly coupled processing circuit within each distributed data node and interfaces directly with the local processor, local memory, and communication interface to ensure that privacy control is enforced prior to any outbound transmission of model updates. When a local training iteration is completed, the local processor produces a gradient structure stored in memory. Before the gradient structure is made available to the communication interface, the differential privacy processor initiates a metadata synchronization routine in which it transmits a dataset identifier and version reference to the metadata management processor and receives corresponding dataset classification tags that indicate the sensitivity category of each attribute used during training. These tags may, for example, identify attributes containing health records, financial transactions, operational logs, or anonymized behavioral metrics. The differential privacy processor caches the returned tags in a protected memory region and associates them with lineage mappings that correlate gradient indices to originating data attributes.

Based on the received classification tags, the differential privacy processor retrieves a parameter profile defining allowable privacy exposure for each category and computes a privacy budget value that governs the magnitude of permissible information leakage during the current training cycle. This budget value is not static but is dynamically derived by evaluating cumulative privacy expenditure recorded in a local tracking register that logs prior perturbation magnitudes applied to the same dataset version. The gradient structure is then partitioned by tracing each gradient component to its source attribute using stored lineage associations. Components influenced by highly sensitive attributes are grouped into dedicated gradient segments, while components derived from lower-sensitivity attributes are grouped separately. This attribute-aware segmentation ensures that perturbation strength is applied proportionally rather than uniformly across the entire gradient structure.

For each gradient segment, the differential privacy processor invokes an integrated random value generation circuit to produce stochastic values, scales those values according to the computed privacy budget corresponding to the associated classification tag, and injects the scaled perturbations directly into the segment through arithmetic combination operations executed within the processor. For example, if a gradient segment corresponds to health-related attributes, the scaling factor applied to the random values is higher than that applied to segments derived from non-sensitive operational metrics, resulting in stronger masking of sensitive influence. The processor then recombines the perturbed segments into a unified perturbed gradient vector while preserving dimensional consistency required for aggregation. The perturbed gradient vector is written into an encrypted memory buffer, after which a cryptographic circuit encrypts the vector using a key provisioned for communication with the federated coordination processor. Only the encrypted perturbed gradient vector is transmitted through the communication interface, and the unperturbed gradient data remains confined within the distributed data node.

By executing attribute-level segmentation, dynamic privacy budget computation, and calibrated perturbation prior to encryption and transmission, the distributed data node ensures that model contribution remains analytically meaningful for global aggregation while preventing reverse inference of sensitive training records. The integration of lineage-aware mapping with privacy budget tracking reduces the probability of cumulative privacy leakage across multiple training rounds, enabling sustained federated learning participation without breaching governance constraints.

In an embodiment, the secure multi-party computation processor of the federated coordination processor is configured to receive encrypted locally updated model parameters from the plurality of distributed data nodes, verify integrity of each encrypted locally updated model parameter using cryptographic signatures associated with the respective distributed data node, organize the encrypted locally updated model parameters into aggregation groups based on jurisdictional metadata tags received from the metadata management processor, perform encrypted arithmetic accumulation within each aggregation group, and generate jurisdiction-specific intermediate aggregated models prior to formation of the updated global model.

In an embodiment, the secure multi-party computation processor is implemented within the federated coordination processor as a dedicated computation circuit that interfaces with the communication interface, secure aggregation memory, and cryptographic interface to ensure that encrypted model contributions are processed without exposure of plaintext parameters. Upon receipt of encrypted locally updated model parameters from each distributed data node, the secure multi-party computation processor first performs an integrity validation sequence. In this sequence, the processor retrieves a corresponding public verification key associated with the transmitting distributed data node, applies a signature verification routine to the received encrypted parameter package, and confirms that the cryptographic signature matches a hash of the transmitted ciphertext. If verification fails, the contribution is isolated in a quarantine buffer and excluded from aggregation, thereby preventing tampered or replayed model updates from influencing the global model.

Once integrity is validated, the processor queries the metadata management processor to obtain jurisdictional metadata tags associated with each distributed data node and the dataset version used during training. These tags specify the regulatory domain under which the model parameters were generated, such as a particular geographic region or legal framework. The secure multi-party computation processor then indexes each encrypted parameter set in secure aggregation memory and assigns it to a logically separated aggregation group corresponding to its jurisdictional classification. For example, encrypted contributions originating from distributed data nodes operating under one regional data protection regime are placed into a first aggregation group, while those operating under a different regime are placed into a second aggregation group. This grouping occurs entirely on encrypted representations, with classification metadata stored separately and used only for routing and grouping logic.

Within each aggregation group, the processor executes encrypted arithmetic accumulation operations supported by the cryptographic scheme employed by the distributed data nodes. The arithmetic accumulation is performed directly on ciphertext representations so that intermediate results remain encrypted throughout computation. The processor iteratively combines encrypted parameter tensors from participating distributed data nodes in the group, storing intermediate encrypted sums in secure aggregation memory. No decryption key is applied during this process, and plaintext parameter values are never reconstructed within the federated coordination processor. When all validated contributions for a jurisdictional group have been combined, the processor generates an encrypted intermediate aggregated model corresponding to that specific jurisdiction.

These jurisdiction-specific intermediate aggregated models are retained in secure aggregation memory and may subsequently be combined or selectively utilized depending on compliance directives received from the compliance enforcement processor. For example, if policy rules permit cross-domain integration only for non-sensitive parameter subsets, the processor can merge permitted encrypted components while retaining separation of restricted components. By verifying integrity prior to grouping, isolating contributions by jurisdictional metadata, and performing arithmetic directly on encrypted data structures, the federated coordination processor maintains confidentiality of local model parameters, prevents unauthorized cross-jurisdiction mixing of regulated data influences, and ensures that only validated and policy-compliant contributions participate in formation of the updated global model.

In an embodiment, the semantic alignment processor of the metadata management processor is configured to parse schema definitions obtained from the distributed data nodes into structural components including attribute names, data types, relational keys, and constraint descriptors, transform the structural components into vectorized schema representations, compute similarity measures between vectorized schema representations and canonical ontology entities stored in the metadata repository, and automatically generate mapping relationships including attribute correspondences and transformation rules that are stored as part of the version-controlled metadata graph.

In an embodiment, the semantic alignment processor operates as a dedicated processing circuit within the metadata management processor and is coupled to the metadata repository and version-controlled metadata graph storage so that schema harmonization is performed in a reproducible and traceable manner. When a distributed data node registers a dataset or initiates participation in a federated learning round, the schema definition of the dataset is transmitted to the metadata management processor in a structured format that includes table definitions, attribute identifiers, declared data types, relational key constraints, and integrity rules. The semantic alignment processor parses this schema definition by decomposing it into discrete structural components and encoding each component into an intermediate representation stored in working memory. Attribute names are tokenized into lexical elements, data types are mapped to normalized type categories, relational keys are identified as graph edges between entities, and constraint descriptors such as uniqueness or range limitations are captured as formal constraint expressions.

After decomposition, the processor transforms each structural component into a vectorized schema representation by applying an embedding routine that converts lexical tokens, type identifiers, and relational context into numerical feature vectors. For example, an attribute labeled “patient_identifier” with a string data type and a uniqueness constraint is converted into a composite vector capturing semantic meaning, structural role, and constraint characteristics. These vectorized representations are then compared against vector representations of canonical ontology entities stored in the metadata repository. The canonical ontology contains standardized entities such as “individual_identifier,” “financial_transaction_amount,” or “diagnostic_code,” each encoded as a reference vector along with associated transformation templates. The semantic alignment processor computes similarity measures between the incoming schema vectors and ontology vectors using a defined similarity computation circuit, ranks candidate ontology matches, and selects the highest-confidence correspondences based on predefined acceptance thresholds.

Once correspondences are identified, the processor automatically generates mapping relationships that define how attributes from the distributed data node schema correspond to entities in the canonical ontology. These mappings include attribute-to-entity correspondences, data type conversion rules, constraint reconciliation logic, and transformation expressions required to normalize attribute formats. For instance, if one distributed data node represents dates as text strings and the canonical ontology defines a standardized date format, the processor generates a transformation rule specifying conversion into the standardized representation. These mapping relationships are stored as structured entries in the version-controlled metadata graph, where each mapping is associated with a dataset identifier and schema version number. Historical versions of mappings are preserved, enabling rollback or comparison when schema changes occur at a distributed data node.

By performing structured parsing, vectorized representation, similarity computation, and automated mapping generation, the semantic alignment processor enables heterogeneous datasets originating from independently managed distributed data nodes to be harmonized into a consistent ontology without manual intervention. This harmonization ensures that federated learning operations reference semantically equivalent attributes across nodes, reduces ambiguity caused by naming inconsistencies, and allows compliance enforcement and lineage tracking mechanisms to operate on unified semantic constructs. The result is improved interoperability across distributed environments, consistent policy application across semantically aligned attributes, and enhanced reliability of aggregated model outcomes derived from structurally diverse datasets.

In an embodiment, the jurisdiction detection processor of the compliance enforcement processor is configured to extract network address identifiers and data residency attributes from metadata records associated with each distributed data node, correlate the extracted information with a jurisdictional rules dataset stored in the policy rule storage device, assign a jurisdictional classification label to each model parameter contribution, and transmit control instructions to the federated coordination processor to isolate parameter aggregation processes into jurisdictionally compliant aggregation domains.

In an embodiment, the jurisdiction detection processor is implemented within the compliance enforcement processor as a rule-evaluation and correlation circuit that interfaces with the metadata repository, the policy rule storage device, and the federated coordination processor. When a distributed data node submits encrypted model parameter contributions for participation in a federated learning round, the metadata management processor associates those contributions with metadata records that include network address identifiers, node registration credentials, declared physical hosting location, and data residency attributes reflecting where the underlying datasets are legally stored. The jurisdiction detection processor retrieves these metadata records and parses the network address identifiers to determine geographic routing information, including region codes derived from allocated address blocks and network routing registries maintained within the policy rule storage device. In parallel, it reads declared residency attributes that specify contractual or statutory restrictions tied to the dataset's origin.

The processor then correlates the extracted network and residency information with a jurisdictional rules dataset stored in the policy rule storage device. This dataset contains structured entries defining regulatory boundaries, cross-border transfer restrictions, aggregation compatibility conditions, and exceptions permitted under specific legal provisions. The correlation routine compares the physical and logical origin indicators of each distributed data node against rule entries to determine the applicable legal domain. For example, if a distributed data node is physically hosted in one region but processes data originating from another region with stricter export restrictions, the processor evaluates both indicators and applies the stricter classification. Based on this evaluation, the jurisdiction detection processor assigns a jurisdictional classification label to the corresponding model parameter contribution. The label is encoded as a structured identifier that accompanies the encrypted parameter set within the secure aggregation memory of the federated coordination processor.

After assigning the jurisdictional classification label, the processor generates control instructions specifying aggregation constraints associated with that label. These instructions may define whether the parameter contribution may be aggregated only with contributions sharing the same classification, whether partial aggregation is permitted under predefined compatibility mappings, or whether the contribution must remain segregated until additional authorization is obtained. The control instructions are transmitted to the federated coordination processor through a secure signaling interface, where they are enforced by isolating encrypted parameter contributions into logically separated aggregation domains. As a result, parameter aggregation operations occur only within domains that satisfy applicable regulatory requirements, and cross-domain mixing of contributions subject to incompatible residency constraints is prevented.

By dynamically extracting origin indicators, correlating them with structured jurisdictional rules, and enforcing aggregation isolation at the ciphertext level, the system maintains regulatory compliance without requiring decryption or manual intervention. This mechanism ensures that federated learning can proceed across geographically distributed nodes while honoring location-specific legal constraints, reducing the risk of unauthorized cross-border influence within aggregated models and enabling traceable enforcement aligned with recorded metadata.

In an embodiment, the cryptographic hashing processor of the lineage tracking processor is configured to generate, for each lineage record, a first hash value derived from dataset identifiers, processing timestamps, model version identifiers, and compliance decision identifiers, to retrieve a preceding hash value corresponding to an immediately prior lineage record, to concatenate the first hash value with the preceding hash value to form a chained hash input, and to compute a chained hash output that is stored in the tamper-evident distributed ledger storage together with the lineage record.

In an embodiment, the cryptographic hashing processor operates as a dedicated hashing circuit within the lineage tracking processor and is coupled to the metadata repository, compliance enforcement processor, and tamper-evident distributed ledger storage so that every operational event in the federated learning lifecycle is recorded in a verifiable sequence. When a lineage event occurs, such as completion of a local training iteration, aggregation of encrypted parameters, deployment of a new global model version, or issuance of a compliance decision, the lineage tracking processor constructs a structured lineage record that includes a dataset identifier, a processing timestamp generated from a synchronized system clock, a model version identifier referencing the specific global or intermediate model state, and a compliance decision identifier corresponding to the enforcement outcome applicable at that stage. The cryptographic hashing processor receives this structured record in serialized form and applies a deterministic hashing routine to generate a first hash value representing the cryptographic fingerprint of the current lineage event.

To ensure sequential integrity, the processor retrieves a preceding hash value associated with the immediately prior lineage record stored in the distributed ledger storage. This preceding hash value is stored as part of the previous record and serves as a linkage anchor. The cryptographic hashing processor concatenates the first hash value derived from the current lineage record with the retrieved preceding hash value to produce a chained hash input. This concatenated input is then processed through the hashing circuit again to compute a chained hash output that cryptographically binds the current lineage record to the entire sequence of prior records. The chained hash output is stored alongside the serialized lineage record in the tamper-evident distributed ledger storage, forming a sequential chain in which alteration of any earlier record would invalidate subsequent chained hash outputs.

For example, if a compliance enforcement decision modifies aggregation eligibility for a particular distributed data node during a specific federated learning round, that decision identifier becomes part of the lineage record for that round. The resulting chained hash output binds the compliance decision, dataset identifier, timestamp, and model version identifier into a single verifiable sequence. If any attempt is made to retroactively alter the compliance decision identifier or modify the associated model version, recalculation of the chained hashes would produce a mismatch, immediately revealing inconsistency. The tamper-evident distributed ledger storage maintains these chained records across multiple storage nodes or replicated memory regions to prevent single-point compromise.

By cryptographically linking each lineage record to its predecessor and embedding operational and compliance metadata into the hash computation process, the system establishes an immutable chronological history of dataset usage, model evolution, and enforcement actions. This approach ensures traceability of model derivation paths, supports forensic reconstruction of training events, and prevents undetected modification of historical records, thereby maintaining reliable auditability and operational integrity across distributed federated learning environments.

In an embodiment, the resource allocation processor of the orchestration processor is configured to periodically retrieve workload metrics from the telemetry collection processor of each distributed data node, determine a weighted resource distribution schedule based on gradient convergence rates and dataset volume characteristics stored in the metadata repository, generate allocation control signals defining participation frequency and computational priority for each distributed data node in subsequent federated learning rounds, and transmit the allocation control signals to the respective distributed data nodes prior to initiation of the subsequent federated learning rounds.

In an embodiment, the resource allocation processor operates as a centralized coordination circuit within the orchestration processor and maintains a synchronized communication channel with the telemetry collection processor of each distributed data node and the metadata repository. At predefined evaluation intervals or upon completion of a federated learning round, the resource allocation processor issues metric retrieval requests to each distributed data node, prompting transmission of structured workload metrics that include processor utilization levels, memory occupancy, network latency indicators, gradient variance measurements, and local model accuracy values observed during recent training iterations. These metrics are received in a normalized format and temporarily stored in a scheduling buffer for comparative analysis.

The processor then correlates the retrieved workload metrics with dataset volume characteristics and classification attributes stored in the metadata repository. For instance, a distributed data node associated with a large dataset containing high informational diversity may exhibit slower gradient convergence but contribute substantial representational value to the global model, whereas a node with a smaller dataset may converge quickly but provide limited incremental learning benefit. The resource allocation processor computes convergence indicators by analyzing changes in gradient variance and accuracy improvements across successive training cycles. These indicators are combined with dataset volume parameters, such as record count and feature dimensionality, to calculate a weighted contribution score for each distributed data node.

Based on the weighted contribution score and current workload constraints, the resource allocation processor generates a resource distribution schedule that defines participation frequency in upcoming federated learning rounds and assigns computational priority levels. For example, a distributed data node demonstrating stable convergence and high data diversity may be scheduled for participation in every round with elevated aggregation weight, while a node experiencing resource saturation or minimal incremental learning impact may be assigned reduced participation frequency. The allocation schedule is encoded into allocation control signals specifying round inclusion flags, local epoch limits, and aggregation weighting parameters. These signals are transmitted to the respective distributed data nodes before initiation of the next federated learning round, ensuring that each node adjusts its local training cycle according to the centrally determined schedule.

By dynamically analyzing telemetry-derived performance indicators in conjunction with metadata-based dataset characteristics, the orchestration processor achieves adaptive load balancing and optimized convergence behavior across the distributed network. This mechanism prevents overutilization of constrained nodes, reduces redundant computation from low-impact contributors, and accelerates stabilization of the global model by prioritizing high-value contributions. The coordinated scheduling process enhances overall computational efficiency, maintains balanced resource consumption across heterogeneous environments, and sustains stable federated learning progression even when distributed data nodes operate under varying hardware capacities and dataset scales.

In an embodiment, the machine learning classifier of the metadata management processor is configured to process dataset samples extracted from the distributed data nodes, generate feature representations corresponding to textual, numerical, and structured data attributes, compute classification outputs indicating presence of personally identifiable information, financial data, health-related information, or confidential enterprise data, update the metadata graph with compliance tags corresponding to the classification outputs, and trigger a compliance validation request to the compliance enforcement processor prior to authorization of model training operations on newly classified datasets.

In an embodiment, the machine learning classifier operates within the metadata management processor as a dedicated classification circuit that interfaces with controlled sampling routines at each distributed data node and with the version-controlled metadata graph. When a distributed data node registers a new dataset or updates an existing dataset version, the metadata management processor initiates a sampling request that extracts representative data segments without transferring entire datasets. These samples are transmitted through a secure channel and stored in an isolated analysis buffer. The machine learning classifier then preprocesses the sampled content according to attribute type. Textual attributes are tokenized and normalized, numerical attributes are scaled and evaluated for statistical patterns such as value distributions and range characteristics, and structured attributes such as identifiers, timestamps, or coded entries are parsed into standardized internal representations.

From the preprocessed content, the classifier generates feature representations capturing semantic, statistical, and structural characteristics of each attribute. For example, textual fields containing names, addresses, or identification numbers produce feature vectors reflecting lexical patterns and format regularities, while numerical fields exhibiting account-like patterns or transaction magnitudes produce statistical signatures consistent with financial data. Health-related attributes may be identified by combinations of medical terminology patterns and structured coding formats. These feature representations are processed through a trained inference circuit that computes classification outputs indicating the likelihood that each attribute corresponds to personally identifiable information, financial data, health-related information, or confidential enterprise data. The classifier assigns category labels based on confidence thresholds stored within the metadata management processor and associates each label with a dataset identifier and version reference.

Upon determination of classification outputs, the metadata management processor updates the version-controlled metadata graph by inserting compliance tags into nodes representing the affected dataset and its attributes. If the dataset is derived from existing datasets, the processor propagates classification tags through lineage edges to ensure that derivative datasets inherit applicable compliance designations. The updated metadata graph reflects the new sensitivity categorization and is stored with a version increment to preserve historical traceability. Immediately after updating the metadata graph, the metadata management processor generates a compliance validation request that is transmitted to the compliance enforcement processor. This request includes dataset identifiers, classification tags, and intended processing actions such as participation in a federated learning round.

The compliance enforcement processor evaluates the request against governance constraints before permitting model training operations to proceed. If the new classification introduces stricter regulatory requirements, the enforcement processor may adjust aggregation eligibility, require enhanced privacy parameters, or temporarily restrict participation. By automatically analyzing dataset samples, generating attribute-level feature representations, updating metadata structures, and enforcing validation before training authorization, the system ensures that newly introduced sensitive content is identified and governed prior to model influence. This process reduces reliance on manual tagging, prevents inadvertent inclusion of regulated data in federated learning cycles, and maintains alignment between evolving dataset content and enforcement controls across distributed data nodes.

In an embodiment, the compliance enforcement processor is configured to construct, prior to execution of a requested data processing workflow, a simulated workflow graph derived from the version-controlled metadata graph, propagate projected metadata state transitions across nodes of the simulated workflow graph including projected lineage entries and projected policy evaluations, detect prohibited data propagation paths by traversing the simulated workflow graph using stored governance constraints, and generate a denial control signal when the traversal identifies a projected violation of at least one regulatory policy stored in the policy rule storage device.

In an embodiment, the compliance enforcement processor operates as a rule-evaluation and graph-analysis circuit that interacts with the version-controlled metadata graph prior to permitting execution of any requested data processing workflow, including initiation of a federated learning round, onboarding of a new distributed data node, or transformation of an existing dataset. When a workflow request is received, the processor does not immediately authorize execution. Instead, it retrieves from the metadata repository the current version-controlled metadata graph that represents datasets, transformation relationships, model dependencies, compliance tags, and jurisdictional classifications. Using the workflow definition submitted by the orchestration processor or a distributed data node, the compliance enforcement processor constructs a simulated workflow graph in memory. This simulated workflow graph is not merely a duplicate of the existing metadata graph but is an augmented graph in which proposed operations are inserted as projected nodes and edges representing anticipated dataset transformations, model updates, aggregation steps, and data access events.

Once the simulated workflow graph is constructed, the compliance enforcement processor propagates projected metadata state transitions through the graph. This propagation involves computing how compliance tags, jurisdictional classifications, sensitivity levels, and access permissions would change if the workflow were executed. For example, if a workflow proposes combining a dataset tagged as containing health-related information with another dataset tagged as financial data, the processor determines whether the resulting derived dataset would inherit both classifications and whether additional regulatory constraints would apply. Similarly, if a federated aggregation step would combine parameter contributions from nodes under different residency rules, the processor evaluates whether the projected lineage entries would cross prohibited jurisdictional boundaries. During this propagation, the processor also simulates generation of lineage records that would be created upon execution, assigning projected timestamps, dataset identifiers, and compliance decision identifiers to ensure the lineage impact is fully evaluated before actual commitment.

The processor then performs a traversal of the simulated workflow graph using governance constraints stored in the policy rule storage device. These constraints are encoded as conditional rules defining disallowed combinations of classification tags, forbidden cross-domain data flows, mandatory isolation requirements, and dependency restrictions. The traversal technique evaluates each potential path from input dataset nodes through transformation nodes to output nodes, checking whether any path violates a stored rule. For instance, if a path indicates that personally identifiable information originating from a restricted jurisdiction would influence a model deployed in a different jurisdiction without approved safeguards, the processor identifies that path as prohibited. The evaluation is performed on the simulated graph, ensuring that no actual data movement or model aggregation occurs before compliance validation is completed.

If a violation is detected, the compliance enforcement processor generates a denial control signal that is transmitted to the orchestration processor and, if applicable, to the federated coordination processor. This denial control signal prevents execution of the requested workflow and records the projected violation in the metadata repository for audit purposes. If no violations are detected, an authorization signal is generated, permitting execution. By constructing a simulated workflow graph, propagating projected metadata state transitions, and traversing projected lineage paths prior to execution, the system prevents non-compliant operations from occurring in the first place. This pre-execution validation mechanism reduces the likelihood of regulatory breaches, eliminates the need for reactive remediation after improper data propagation, and ensures that federated learning and data processing activities proceed only when all projected interactions remain within defined governance boundaries.

In an embodiment, the telemetry collection processor of each distributed data node is configured to compute temporal sequences of gradient variance values and model accuracy metrics during successive local training iterations, transmit aggregated telemetry summaries including convergence indicators and drift detection flags to the metadata management processor, and wherein the metadata management processor updates performance attributes within the metadata repository and transmits adaptive policy adjustment signals to the compliance enforcement processor when the convergence indicators or drift detection flags exceed predefined thresholds associated with regulatory risk categories.

In an embodiment, the telemetry collection processor is implemented within each distributed data node as a monitoring circuit that interfaces directly with the local processor executing model training routines and with the local memory storing intermediate gradient and model state information. During successive local training iterations, the telemetry collection processor intercepts gradient tensors produced after each batch or epoch and computes statistical descriptors including variance magnitude across gradient components, rate of change of variance between iterations, and stability indices derived from moving averages over defined time windows. In parallel, the processor retrieves locally computed validation metrics such as prediction accuracy, loss values, and error distributions calculated against a validation subset retained within the distributed data node. These measurements are time-stamped using a synchronized clock reference and stored sequentially to form temporal sequences that reflect the dynamic behavior of the model during training.

The telemetry collection processor applies a convergence analysis routine that evaluates whether gradient variance decreases consistently over iterations and whether accuracy metrics stabilize within an acceptable range. If oscillatory patterns or abrupt divergence are detected, the processor sets internal flags indicating potential instability. Additionally, a drift detection routine compares current validation performance metrics against historical baselines associated with prior dataset versions stored in the local memory. For example, if the distributed data node receives newly ingested data that shifts feature distributions, the telemetry collection processor detects statistically significant deviation in gradient patterns or accuracy curves relative to baseline references and generates a drift detection flag. Rather than transmitting raw training data or detailed gradient values, the processor aggregates the computed statistics into summarized telemetry records containing convergence indicators, stability indices, and drift flags. These summaries are encrypted and transmitted to the metadata management processor through the communication interface.

Upon receipt, the metadata management processor updates performance attributes in the metadata repository by associating the received telemetry summaries with the corresponding dataset identifiers, model version identifiers, and jurisdictional classifications. The repository thus maintains a longitudinal performance profile for each distributed data node and dataset combination. If the convergence indicators reveal excessive instability or if drift detection flags exceed thresholds associated with predefined regulatory risk categories, the metadata management processor generates adaptive policy adjustment signals. These signals are transmitted to the compliance enforcement processor and may specify, for example, temporary restriction of aggregation participation, requirement for increased privacy perturbation parameters, or initiation of additional compliance validation prior to further training rounds. By continuously analyzing temporal gradient behavior and accuracy evolution, and by linking telemetry findings with governance controls, the system dynamically adjusts operational policies in response to model instability or dataset drift. This closed-loop interaction enhances reliability of federated learning outcomes, prevents propagation of anomalous or biased updates into the global model, and maintains alignment between training performance characteristics and regulatory oversight requirements across distributed environments.

In an embodiment, the orchestration processor is configured to enforce synchronization intervals for federated learning rounds by generating a round initiation signal only after verifying, through the metadata management processor, that metadata normalization processes are completed and, through the compliance enforcement processor, that no outstanding policy violations are recorded for participating distributed data nodes, and wherein the orchestration processor further suspends participation of a distributed data node in a subsequent federated learning round upon receipt of a violation notification generated by the compliance enforcement processor.

In an embodiment, the orchestration processor operates as a centralized coordination circuit that maintains state information regarding federated learning round cycles, metadata processing status, and compliance validation outcomes for each participating distributed data node. Prior to initiating a new federated learning round, the orchestration processor executes a verification sequence in which it queries the metadata management processor to confirm completion of metadata normalization for all datasets intended to participate in the upcoming round. This verification involves checking status flags associated with schema alignment, classification tagging, and lineage updates stored in the metadata repository. If any dataset linked to a distributed data node remains in a pending normalization state, the orchestration processor defers round initiation and maintains the system in a standby state until normalization status is updated to complete.

Concurrently, the orchestration processor communicates with the compliance enforcement processor to retrieve policy validation status indicators for each distributed data node. These indicators reflect whether any outstanding violations, unresolved jurisdictional conflicts, privacy budget exceedances, or governance constraint breaches have been recorded in association with the node's most recent activities. The orchestration processor evaluates the validation responses and constructs an eligibility matrix that identifies which distributed data nodes are cleared for participation. Only when all required metadata normalization processes are confirmed complete and all participating distributed data nodes are verified as free from active compliance violations does the orchestration processor generate a round initiation signal. This signal is transmitted to the federated coordination processor and to each eligible distributed data node, triggering synchronized commencement of the federated learning cycle.

During an active federated learning round or between rounds, if the compliance enforcement processor detects a policy violation, such as a newly identified regulatory constraint, improper dataset classification, or privacy threshold breach, it generates a violation notification and transmits it to the orchestration processor. Upon receipt of this notification, the orchestration processor updates its internal eligibility matrix and immediately suspends participation of the affected distributed data node. Suspension may involve halting acceptance of encrypted parameter contributions from that node, excluding its contributions from aggregation buffers, and preventing issuance of subsequent round initiation signals to the node until remediation is confirmed. The orchestration processor records the suspension event in coordination with the lineage tracking processor to ensure traceability.

By enforcing pre-round verification of metadata readiness and compliance status, and by dynamically suspending nodes upon detection of violations, the orchestration processor ensures that federated learning rounds proceed only with validated and policy-compliant participants. This coordination mechanism prevents propagation of non-compliant or improperly classified data influences into aggregated models, maintains synchronized system operation across heterogeneous nodes, and preserves integrity of the federated learning lifecycle under evolving regulatory and metadata conditions.

In an embodiment, the secure aggregation memory of the federated coordination processor is configured to maintain separate encrypted parameter buffers corresponding to distinct compliance tags assigned by the metadata management processor, sequentially merge encrypted parameter buffers only when the compliance enforcement processor confirms compatibility of the respective compliance tags, and generate the updated global model by combining outputs of the merged encrypted parameter buffers in accordance with aggregation control instructions issued by the orchestration processor.

In an embodiment, the secure aggregation memory operates as an isolated encrypted storage region within the federated coordination processor and is logically partitioned into multiple buffer segments, each segment being indexed by a compliance tag identifier received from the metadata management processor. When encrypted locally updated model parameters arrive from distributed data nodes, the federated coordination processor queries the metadata repository to retrieve the compliance tags associated with the dataset and training context that produced the parameters. Based on the retrieved tag identifier, the encrypted parameter set is written into a corresponding encrypted parameter buffer within the secure aggregation memory. Each buffer is segregated at the memory management level so that encrypted contributions associated with different regulatory categories, sensitivity classifications, or jurisdictional constraints are not co-mingled at the storage stage.

The secure aggregation memory maintains buffer metadata entries that record the compliance tag, model version reference, and contributing distributed data node identifiers for each encrypted parameter set. When sufficient contributions have been accumulated in a particular buffer, the federated coordination processor transmits a compatibility verification request to the compliance enforcement processor. This request includes the compliance tags of buffers proposed for merging. The compliance enforcement processor evaluates stored governance rules and determines whether the specified compliance tags are compatible for aggregation, for example by verifying that they belong to the same jurisdictional domain or share an approved compatibility mapping. Only upon receipt of an explicit compatibility confirmation signal does the federated coordination processor permit sequential merging of the respective encrypted parameter buffers.

The merging operation is performed in stages. First, encrypted parameter tensors within each approved buffer are combined using encrypted arithmetic accumulation routines to generate intermediate encrypted aggregates. If multiple buffers are deemed compatible, their intermediate encrypted aggregates are subsequently combined into a unified encrypted representation. Throughout this process, the encrypted state of the parameters is preserved, and no decryption occurs within the secure aggregation memory. The orchestration processor provides aggregation control instructions specifying weighting factors, inclusion order, and round-specific aggregation rules, which are applied during the encrypted combination sequence. Once merging is complete according to the authorized control instructions, the federated coordination processor generates the updated global model representation, which may remain encrypted until distribution or may be decrypted only within a controlled cryptographic boundary depending on system configuration.

By maintaining physically and logically separated encrypted parameter buffers keyed to compliance tags and enforcing compatibility validation prior to merging, the system prevents unauthorized blending of parameter contributions subject to distinct regulatory or sensitivity constraints. This buffer-level segregation combined with controlled sequential merging ensures that global model updates reflect only policy-compliant combinations of distributed contributions, reduces the risk of cross-domain regulatory violations, and preserves traceability of aggregation lineage within the federated learning process.

In an embodiment, each processor, unit, memory, storage device, interface, and circuitry described herein is implemented as a tangible hardware component integrated within a computing architecture comprising one or more physical processing circuits, semiconductor-based logic elements, and electrically addressable memory devices. Each distributed data node includes a physical local processor formed by a microprocessor or multi-core processing circuit mounted on a circuit board, coupled through a system bus to volatile memory such as random access memory and non-volatile storage such as solid-state storage media, and further coupled to a network communication interface implemented as a hardware network controller with transceiver circuitry. The federated coordination processor, metadata management processor, compliance enforcement processor, lineage tracking processor, orchestration processor, semantic alignment processor, jurisdiction detection processor, differential privacy processor, telemetry collection processor, cryptographic hashing processor, and secure multi-party computation processor are each realized as dedicated hardware processing circuits or co-processors that execute stored machine instructions from non-transitory memory, and may be implemented as separate physical processing units or as isolated logical cores within a multi-core processing architecture, with hardware-enforced memory segmentation to prevent unauthorized data access between functional blocks. The secure aggregation memory, metadata repository storage, policy rule storage device, and tamper-evident distributed ledger storage are each implemented as physically addressable non-transitory storage media, including persistent semiconductor storage arrays or magnetic storage devices, configured to store structured data records and cryptographic values. Cryptographic operations, hashing functions, encrypted arithmetic operations, and random value generation routines are executed by dedicated hardware cryptographic circuits or instruction-level hardware accelerators integrated within the processing architecture. Communication between components occurs over physical data buses or network links through hardware network interfaces supporting secure data transmission protocols. Each functional element therefore corresponds to a concrete hardware structure capable of electrical signal processing, data storage, and instruction execution, ensuring that all described operations are performed by physical computing machinery rather than abstract logic, and enabling practical implementation within distributed computing systems deployed across multiple networked hardware nodes.

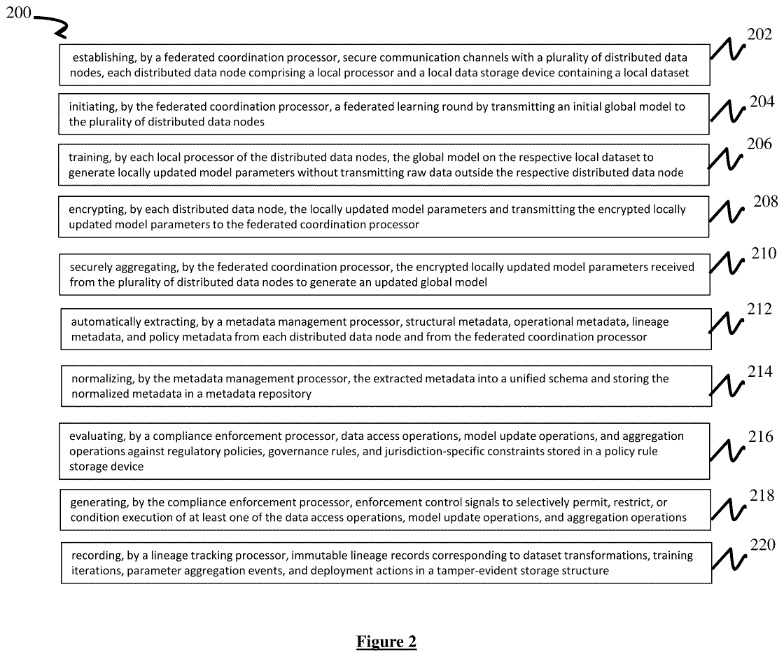

Referring to FIG. 2, a flow chart of a method for a computer-implemented method for federated learning-driven intelligent data mesh operation with automated metadata management and compliance enforcement, the method is illustrated. The method 200 comprising:

At step 202, the method 200 includes establishing, by a federated coordination processor, secure communication channels with a plurality of distributed data nodes, each distributed data node comprising a local processor and a local data storage device containing a local dataset;

At step 204, the method 200 includes initiating, by the federated coordination processor, a federated learning round by transmitting an initial global model to the plurality of distributed data nodes;

At step 206, the method 200 includes training, by each local processor of the distributed data nodes, the global model on the respective local dataset to generate locally updated model parameters without transmitting raw data outside the respective distributed data node;

At step 208, the method 200 includes encrypting, by each distributed data node, the locally updated model parameters and transmitting the encrypted locally updated model parameters to the federated coordination processor;

At step 210, the method 200 includes securely aggregating, by the federated coordination processor, the encrypted locally updated model parameters received from the plurality of distributed data nodes to generate an updated global model;

At step 212, the method 200 includes automatically extracting, by a metadata management processor, structural metadata, operational metadata, lineage metadata, and policy metadata from each distributed data node and from the federated coordination processor;

At step 214, the method 200 includes normalizing, by the metadata management processor, the extracted metadata into a unified schema and storing the normalized metadata in a metadata repository;

At step 216, the method 200 includes evaluating, by a compliance enforcement processor, data access operations, model update operations, and aggregation operations against regulatory policies, governance rules, and jurisdiction-specific constraints stored in a policy rule storage device;

At step 218, the method 200 includes generating, by the compliance enforcement processor, enforcement control signals to selectively permit, restrict, or condition execution of at least one of the data access operations, model update operations, and aggregation operations; and

At step 220, the method 200 includes recording, by a lineage tracking processor, immutable lineage records corresponding to dataset transformations, training iterations, parameter aggregation events, and deployment actions in a tamper-evident storage structure.

In an embodiment, further comprising applying, by each distributed data node, a differential privacy operation to locally computed model gradients prior to encryption, wherein a magnitude of noise applied is dynamically determined based on metadata classification tags associated with the respective local dataset.

In an embodiment, securely aggregating the encrypted locally updated model parameters comprises performing encrypted arithmetic operations on the encrypted locally updated model parameters without decrypting individual contributions, thereby preserving confidentiality of each distributed data node.

In an embodiment, further comprising performing, by the metadata management processor, semantic alignment of heterogeneous dataset schemas received from different distributed data nodes into a canonical ontology, including entity resolution and attribute harmonization based on learned schema matching models.

In an embodiment, further comprising determining, by the compliance enforcement processor, a geographic origin of each dataset and corresponding model parameter contribution based on stored residency attributes and network identifiers, and automatically preventing cross-border aggregation when such aggregation violates stored regulatory constraints.

In an embodiment, further comprising generating, by the lineage tracking processor, cryptographic hash values for each lineage record and linking successive lineage records using chained hash references to create an immutable audit trail.

In an embodiment, further comprising allocating, by an orchestration processor, computational resources among the plurality of distributed data nodes based on workload metrics, dataset size characteristics, and historical model convergence behavior to optimize federated learning round completion time while satisfying compliance constraints.

In an embodiment, further comprising automatically classifying, by the metadata management processor, datasets to identify personally identifiable information, financial information, health-related information, and confidential enterprise information, assigning compliance tags to the datasets, and supplying the compliance tags to the compliance enforcement processor for rule evaluation.

In an embodiment, further comprising simulating, by the compliance enforcement processor prior to execution, a proposed data processing workflow by evaluating projected metadata state transitions and lineage impacts, and denying execution of the proposed data processing workflow when the projected metadata state transitions violate stored governance rules.

In an embodiment, further comprising associating, by the lineage tracking processor, each aggregated global model update with a corresponding metadata snapshot identifier stored in the metadata repository, thereby enabling reconstruction of historical training states, compliance decisions, and dataset configurations for audit and regulatory reporting purposes.

The present invention implements a federated learning-driven intelligent data mesh architecture in which distributed domain nodes collaboratively train a shared machine learning model while preserving data locality, enforcing automated metadata governance, and ensuring deterministic regulatory compliance through coordinated technique procedures executed across domain nodes and a mesh coordination computing assembly. The technique operation begins with initialization of a global model parameter set at the mesh coordination computing assembly. Said global model parameter set is stored in secured aggregation memory and digitally signed using cryptographic circuitry before distribution. The secure communication interface authenticates each participating domain node by verifying a device-bound cryptographic identity stored in tamper-resistant memory within the respective domain node. Only after successful certificate validation and integrity attestation is the global model parameter set transmitted to the federated training processor at each authenticated domain node.

Upon receipt of the global model parameter set, the federated training processor allocates dedicated gradient buffer memory and initializes tensor computation circuitry to perform localized iterative optimization on domain-resident datasets. The local training technique operates in epochs, wherein each epoch includes partitioning of locally stored datasets into mini-batches, forward propagation through neural computation layers, computation of loss values based on predicted and actual outputs, backward propagation to compute gradients, and parameter update calculations. Gradient magnitudes are evaluated using arithmetic logic circuitry to ensure numerical stability and bounded update values. A validation routine executed prior to transmission verifies that computed gradients do not exceed predefined magnitude thresholds or violate structural integrity constraints of the model parameter space. If validation fails, the secure parameter isolation circuit prevents transmission and logs a compliance event.

Concurrently with local training, the metadata acquisition processor intercepts data ingestion and transformation instructions executed within the domain node. Each transformation instruction is parsed to extract input dataset identifiers, output dataset identifiers, transformation parameters, timestamps, and associated model version identifiers. These extracted elements are encoded into structured lineage descriptors stored in persistent metadata registers. Schema definitions, ownership identifiers, access privilege attributes, and processing context parameters are similarly extracted. The semantic harmonization processor then transforms domain-specific terminology and schema attributes into a canonical ontology representation using mapping tables and ontology translation circuitry. The harmonized metadata is stored in synchronized metadata memory awaiting transmission.

Before model parameter updates are encrypted for transmission, the compliance validation processor executes deterministic rule evaluation logic. Said logic compares harmonized metadata attributes and real-time telemetry signals against regulatory constraints including data residency restrictions, cross-border transfer limitations, consent state indicators, data retention schedules, and role-based access privileges. Telemetry signals are generated by monitoring dataset read operations, dataset write operations, user authentication events, configuration modifications, and model deployment activities. If any violation condition is detected, a hardware interrupt signal is generated to suspend the training cycle and disable the network interface circuit until remediation occurs. If no violation is detected, the local model parameter updates and harmonized metadata are forwarded to the hardware cryptographic processor.

The hardware cryptographic processor encrypts the local model parameter updates using keys stored in tamper-resistant memory and generates a digital signature associated with the device-bound cryptographic identity of the domain node. The encrypted payload and associated signature are transmitted through the network interface circuit to the mesh coordination computing assembly. Upon receipt, the secure communication interface verifies the digital signature and authenticates the originating domain node. Only verified and authenticated payloads are admitted for aggregation.

The federated aggregation processor executes an aggregation technique that computes a global model update without accessing raw datasets. The aggregation technique operates by decrypting verified parameter updates within secure memory and performing weighted averaging of corresponding model parameters across domain nodes. Adaptive weighting circuitry assigns aggregation weights based on compliance state indicators, historical trust scores stored in immutable audit storage memory, metadata completeness metrics, and anomaly indicators transmitted from domain nodes. Domain nodes exhibiting anomalous behavior or non-compliant status are assigned reduced weights or excluded entirely from the aggregation cycle. The resulting aggregated parameter set constitutes the updated global model parameter set.

Simultaneously, the lineage graph construction processor updates a directed acyclic graph representing cross-domain dataset transformations and model training dependencies. Each new lineage descriptor received from domain nodes is inserted as a node or edge in the graph memory structure. The graph supports adjacency matrix and adjacency list representations, enabling efficient traversal and impact analysis. The compliance rule evaluation processor traverses the directed acyclic graph to detect data propagation paths that may violate regulatory constraints, such as unauthorized cross-domain transfers or improper reuse of consent-restricted datasets. When violations are detected at the global level, enforcement directives are generated and transmitted to affected domain nodes.

Each aggregation cycle, compliance evaluation outcome, metadata synchronization event, and enforcement directive is recorded in immutable audit storage memory configured as a cryptographic hash-linked record structure. Each record includes a secure timestamp, a hash of the preceding record, a digital signature of the originating entity, a compliance evaluation result, and an identifier corresponding to the model training cycle. The cryptographic linkage ensures tamper evidence and traceability. Verification of digital signatures is performed before record commitment to ensure integrity.

Following aggregation, the updated global model parameter set and revised regulatory rule sets are digitally signed and transmitted back to authenticated domain nodes. Upon receipt, each domain node verifies the signature, updates its local model parameters, and integrates updated regulatory rule sets into the compliance validation processor. Subsequent training cycles operate under the revised rule set, enabling adaptive governance. If regulatory constraints change or new compliance requirements are introduced, updated rule definitions are synchronized across domain nodes prior to the next training iteration.

The technique thus establishes a continuous federated training loop with integrated metadata harmonization and compliance enforcement. Each iteration comprises local training with gradient validation, metadata extraction and harmonization, deterministic compliance evaluation, encrypted parameter transmission, authenticated aggregation with adaptive weighting, directed acyclic graph update, global compliance verification, immutable audit recording, and redistribution of updated model parameters and regulatory rule sets. The secure parameter isolation circuit ensures that raw datasets and intermediate feature representations remain confined to respective domain nodes at all times. Through this coordinated sequence of technique steps, the system achieves distributed collaborative intelligence while maintaining regulatory adherence, metadata transparency, auditability, and secure computation across heterogeneous enterprise environments.

In an embodiment, the system comprises a plurality of distributed domain nodes, each domain node being a structurally independent computing unit comprising a local data repository interface, a federated training processor, a metadata extraction engine, and a compliance validation circuit. The federated training processor includes a dedicated tensor computation accelerator configured to perform iterative optimization using stochastic gradient descent or adaptive gradient techniques on locally stored datasets. The training processor is electrically coupled to a secure parameter isolation module that prevents raw data export beyond the local domain boundary.

Each domain node further includes a metadata acquisition and transformation module configured to automatically extract schema definitions, data lineage markers, ownership identifiers, access control parameters, and transformation logs from local data repositories. The metadata is encoded into structured machine-readable descriptors using a metadata serialization protocol stored within a persistent metadata register. The metadata acquisition module is coupled to a semantic harmonization processor configured to map domain-specific ontologies into a global ontology schema maintained by a mesh coordination fabric.

The mesh coordination fabric comprises a distributed orchestration controller implemented as a multi-core processing cluster with high-speed interconnects. The controller includes a federated aggregation engine configured to receive encrypted model updates from the plurality of domain nodes through a secure communication interface incorporating transport-layer encryption and hardware-level key management. The aggregation engine performs weighted averaging or secure multi-party computation to derive a global model update without exposing individual domain contributions.

The secure communication interface includes a hardware-embedded cryptographic processor supporting asymmetric key exchange, symmetric encryption acceleration, digital signature verification, and hash-based message authentication. Each domain node is provisioned with a device-bound cryptographic identity stored in tamper-resistant secure memory, ensuring that only authenticated nodes participate in federated training cycles.

The automated metadata management subsystem is integrated within the mesh coordination fabric and includes a metadata indexing engine, a lineage graph constructor, and a metadata compliance evaluator. The lineage graph constructor generates a directed acyclic graph representing dataset transformations, model training dependencies, and data flow relationships across domains. The graph structure is stored in a graph memory array optimized for adjacency matrix and adjacency list representations. The compliance evaluator is configured to evaluate regulatory constraints, data localization rules, retention schedules, and consent policies by executing rule-based validation techniques on the metadata graph.

In an embodiment, the compliance enforcement engine includes a hardware-assisted policy enforcement module configured to intercept data access requests at the domain node level. The module performs real-time validation against dynamically synchronized policy rules received from the mesh coordination fabric. If a violation condition is detected, the enforcement module generates an interrupt signal to suspend data processing operations and logs the violation in an immutable audit ledger.

The immutable audit ledger comprises a cryptographic hash chain structure stored in append-only memory, where each record includes timestamped compliance events, model training cycles, metadata updates, and policy modifications. The ledger may optionally anchor hash digests to an external distributed verification network to ensure non-repudiation.

The intelligent data mesh device comprises a structural housing containing a federated processing unit, a compliance validation coprocessor, a metadata harmonization accelerator, volatile and non-volatile memory modules, network interface circuitry, and a hardware security module. The federated processing unit includes parallel arithmetic logic arrays configured to perform tensor operations for machine learning model training and inference. The compliance validation coprocessor includes a rule execution engine implemented as microcoded logic circuits capable of executing policy scripts in deterministic cycles.

The device further includes a telemetry capture interface configured to monitor data access patterns, user authentication signals, dataset modification events, and model deployment operations. The telemetry signals are routed to a behavioral analysis processor configured to detect anomalies using statistical divergence detection and pattern recognition models trained via federated learning.

During operation, the method comprises initiating a federated training cycle by transmitting a global model initialization parameter set from the mesh coordination fabric to each authenticated domain node. Each domain node performs local training using its federated training processor while retaining raw data locally. The node generates gradient updates and encrypts the updates using a device-bound cryptographic key prior to transmission. Concurrently, the metadata acquisition module extracts updated lineage descriptors and compliance states, which are transmitted alongside model parameters.

Upon receipt, the federated aggregation engine verifies digital signatures, decrypts gradient parameters, and computes a global model update. The metadata management subsystem updates the global lineage graph and executes compliance evaluation routines. If new regulatory policies are triggered, updated enforcement scripts are propagated to domain nodes.

The system further includes adaptive governance feedback wherein the compliance enforcement engine dynamically adjusts model training parameters based on regulatory constraints. For example, if a data residency violation is detected, the system restricts participation of specific nodes in subsequent training cycles and rebalances aggregation weights accordingly.

The intelligent data mesh device may be deployed as a rack-mounted appliance, edge gateway module, or embedded industrial computing unit within a distributed enterprise network. The structural arrangement ensures electromagnetic shielding of cryptographic components, thermal dissipation channels for high-performance processors, and redundant power regulation circuits for uninterrupted operation.

Through the integration of federated learning processors, automated metadata harmonization, hardware-level compliance enforcement, and secure aggregation infrastructure, the present invention provides a resilient and scalable architecture for distributed intelligent data management while preserving privacy, ensuring regulatory adherence, and maintaining cryptographic traceability across distributed domains.

The disclosed system eliminates centralized data transfer risks by retaining raw data within local domains while enabling collaborative intelligence generation. The automated metadata extraction and harmonization improve governance transparency and reduce manual cataloging overhead. Hardware-assisted compliance enforcement ensures deterministic regulatory validation and prevents unauthorized data usage. The immutable audit ledger enhances accountability and supports forensic verification. The structural intelligent data mesh device enables secure, high-performance deployment across distributed infrastructures, thereby providing a comprehensive solution for federated, compliant, and intelligent data ecosystems.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A federated learning-driven intelligent data mesh system with automated metadata management and compliance enforcement, the system comprising:
a plurality of distributed data nodes, each data node comprising a local data storage device, a local processor, a local memory, and a communication interface, the local processor being configured to train a machine learning model on locally stored datasets without transmitting raw data outside the respective data node;
a federated coordination processor in communication with the plurality of distributed data nodes through a secure communication network, the federated coordination processor comprising a central processing circuit, a secure aggregation memory, and a cryptographic interface, wherein the federated coordination processor is configured to receive encrypted model parameters from each distributed data node, to perform secure aggregation of the encrypted model parameters, and to generate an updated global model;
a metadata management processor coupled to a metadata repository stored in a non-transitory storage device, the metadata management processor being configured to automatically extract structural metadata, operational metadata, lineage metadata, and policy metadata from each distributed data node, to normalize the extracted metadata into a unified schema, and to maintain a version-controlled metadata graph representing relationships between datasets, processing operations, model versions, and access policies;
a compliance enforcement processor coupled to a policy rule storage device, the compliance enforcement processor being configured to evaluate data access requests and model update operations against regulatory policies, organizational governance rules, and jurisdiction-specific data residency constraints, and to generate enforcement signals that selectively permit, restrict, or condition execution of data operations within the plurality of distributed data nodes;
a lineage tracking processor configured to generate immutable lineage records corresponding to dataset transformations, model training iterations, parameter aggregation events, and deployment actions, and to store the lineage records in a tamper-evident distributed ledger storage; and
an orchestration processor configured to coordinate execution sequences among the distributed data nodes, the federated coordination processor, the metadata management processor, and the compliance enforcement processor, wherein the orchestration processor enforces dependency constraints and synchronization intervals for federated learning rounds, metadata updates, and compliance validation cycles, wherein the orchestration processor is configured to enforce synchronization intervals for federated learning rounds by generating a round initiation signal only after verifying, through the metadata management processor, that metadata normalization processes are completed and, through the compliance enforcement processor, that no outstanding policy violations are recorded for participating distributed data nodes, and wherein the orchestration processor further suspends participation of a distributed data node in a subsequent federated learning round upon receipt of a violation notification generated by the compliance enforcement processor.

2. The system of claim 1, wherein each distributed data node further comprises a differential privacy processor configured to apply noise injection to locally computed model gradients prior to encryption, the noise injection being dynamically parameterized based on sensitivity levels derived from metadata classifications stored in the metadata repository, thereby ensuring privacy preservation while maintaining model convergence characteristics, and wherein the federated coordination processor further comprises a secure multi-party computation processor configured to perform parameter aggregation using encrypted arithmetic operations without decrypting individual model parameters, and wherein the secure aggregation memory stores temporary encrypted tensors until completion of aggregation across all participating distributed data nodes.

3. The system of claim 1, wherein the metadata management processor further comprises a semantic alignment processor configured to map heterogeneous schema definitions from different distributed data nodes into a canonical ontology stored in the metadata repository, and wherein the semantic alignment processor performs automated entity resolution and attribute harmonization using learned schema matching models, and wherein the compliance enforcement processor further comprises a jurisdiction detection processor configured to determine geographic origin of each dataset and model parameter based on network identifiers and stored data residency attributes, and to automatically enforce geographic boundary restrictions by preventing cross-border parameter aggregation when prohibited by stored regulatory policies.

4. The system of claim 1, wherein the lineage tracking processor further comprises a cryptographic hashing processor configured to generate hash values for each lineage record, and to link successive lineage records through chained hash references to form an immutable audit trail resistant to unauthorized modification, and wherein the orchestration processor further comprises a resource allocation processor configured to allocate computational resources across the plurality of distributed data nodes based on workload metrics, data volume characteristics, and historical convergence rates, thereby optimizing federated learning round completion time while maintaining compliance constraints.

5. The system of claim 1, wherein the metadata management processor is further configured to automatically classify datasets using a machine learning classifier trained to identify personally identifiable information, financial data, health-related information, and confidential enterprise data, and to assign compliance tags that are subsequently consumed by the compliance enforcement processor during rule evaluation, and wherein the compliance enforcement processor is further configured to perform pre-execution simulation of a requested data processing workflow by evaluating potential metadata state transitions and lineage impacts, and to deny execution if the simulated workflow violates stored governance rules or introduces prohibited data propagation paths within the metadata graph.

6. The system of claim 1, wherein each distributed data node further comprises a telemetry collection processor configured to monitor training duration, gradient variance, model accuracy metrics, and data drift indicators, and to transmit summarized telemetry data to the metadata management processor, wherein the metadata management processor updates performance attributes within the metadata repository to support adaptive compliance and orchestration decisions.

7. The system of claim 2, wherein the differential privacy processor of each distributed data node is configured to determine the sensitivity levels by retrieving dataset classification tags from the metadata repository through the metadata management processor, generating a privacy budget value corresponding to each classification tag, partitioning locally computed model gradients into gradient segments corresponding to classified data attributes, injecting calibrated stochastic perturbations into each gradient segment based on the respective privacy budget value, and generating a perturbed gradient vector that is subsequently encrypted and transmitted to the federated coordination processor.

8. The system of claim 2, wherein the secure multi-party computation processor of the federated coordination processor is configured to receive encrypted locally updated model parameters from the plurality of distributed data nodes, verify integrity of each encrypted locally updated model parameter using cryptographic signatures associated with the respective distributed data node, organize the encrypted locally updated model parameters into aggregation groups based on jurisdictional metadata tags received from the metadata management processor, perform encrypted arithmetic accumulation within each aggregation group, and generate jurisdiction-specific intermediate aggregated models prior to formation of the updated global model.

9. The system of claim 3, wherein the semantic alignment processor of the metadata management processor is configured to parse schema definitions obtained from the distributed data nodes into structural components including attribute names, data types, relational keys, and constraint descriptors, transform the structural components into vectorized schema representations, compute similarity measures between vectorized schema representations and canonical ontology entities stored in the metadata repository, and automatically generate mapping relationships including attribute correspondences and transformation rules that are stored as part of the version-controlled metadata graph.

10. The system of claim 3, wherein the jurisdiction detection processor of the compliance enforcement processor is configured to extract network address identifiers and data residency attributes from metadata records associated with each distributed data node, correlate the extracted information with a jurisdictional rules dataset stored in the policy rule storage device, assign a jurisdictional classification label to each model parameter contribution, and transmit control instructions to the federated coordination processor to isolate parameter aggregation processes into jurisdictionally compliant aggregation domains.

11. The system of claim 4, wherein the cryptographic hashing processor of the lineage tracking processor is configured to generate, for each lineage record, a first hash value derived from dataset identifiers, processing timestamps, model version identifiers, and compliance decision identifiers, to retrieve a preceding hash value corresponding to an immediately prior lineage record, to concatenate the first hash value with the preceding hash value to form a chained hash input, and to compute a chained hash output that is stored in the tamper-evident distributed ledger storage together with the lineage record.

12. The system of claim 4, wherein the resource allocation processor of the orchestration processor is configured to periodically retrieve workload metrics from the telemetry collection processor of each distributed data node, determine a weighted resource distribution schedule based on gradient convergence rates and dataset volume characteristics stored in the metadata repository, generate allocation control signals defining participation frequency and computational priority for each distributed data node in subsequent federated learning rounds, and transmit the allocation control signals to the respective distributed data nodes prior to initiation of the subsequent federated learning rounds.

13. The system of claim 5, wherein the machine learning classifier of the metadata management processor is configured to process dataset samples extracted from the distributed data nodes, generate feature representations corresponding to textual, numerical, and structured data attributes, compute classification outputs indicating presence of personally identifiable information, financial data, health-related information, or confidential enterprise data, update the metadata graph with compliance tags corresponding to the classification outputs, and trigger a compliance validation request to the compliance enforcement processor prior to authorization of model training operations on newly classified datasets.

14. The system of claim 5, wherein the compliance enforcement processor is configured to construct, prior to execution of a requested data processing workflow, a simulated workflow graph derived from the version-controlled metadata graph, propagate projected metadata state transitions across nodes of the simulated workflow graph including projected lineage entries and projected policy evaluations, detect prohibited data propagation paths by traversing the simulated workflow graph using stored governance constraints, and generate a denial control signal when the traversal identifies a projected violation of at least one regulatory policy stored in the policy rule storage device.

15. The system of claim 6, wherein the telemetry collection processor of each distributed data node is configured to compute temporal sequences of gradient variance values and model accuracy metrics during successive local training iterations, transmit aggregated telemetry summaries including convergence indicators and drift detection flags to the metadata management processor, and wherein the metadata management processor updates performance attributes within the metadata repository and transmits adaptive policy adjustment signals to the compliance enforcement processor when the convergence indicators or drift detection flags exceed predefined thresholds associated with regulatory risk categories.

16. The system of claim 2, wherein the secure aggregation memory of the federated coordination processor is configured to maintain separate encrypted parameter buffers corresponding to distinct compliance tags assigned by the metadata management processor, sequentially merge encrypted parameter buffers only when the compliance enforcement processor confirms compatibility of the respective compliance tags, and generate the updated global model by combining outputs of the merged encrypted parameter buffers in accordance with aggregation control instructions issued by the orchestration processor.
